(19) United States
(12) Patent Application Publication
(10) Pub. No.: US 2025/0005411 A1
(43) Pub. Date: Jan. 2, 2025

(54) Robust multi-qubit gates for quantum computing

(71) Applicant: YEDA RESEARCH AND DEVELOPMENT CO. LTD., Rehovot (IL)

(72) Inventors: Roee Ozeri, Rehovot (IL); Adiel Stern, Tel-Aviv (IL); Yotam Shapira, Rehovot (IL); Sapir Cohen, Azor (IL); Nitzan Akerman, Rehovot (IL)

(21) Appl. No.: 18/704,571

(22) PCT Filed: Dec. 7, 2022
(86) PCT No.: PCT/IB2022/061873

§ 371 Date: Apr. 25, 2024

Related U.S. Application Data
(60) Provisional application No. 63/287,105, filed on Dec. 8, 2021.

(51) Int. Cl. G06N 10/20; G06N 10/40

(52) U.S. Cl. CPC G06N 10/20; G06N 10/40

(57) ABSTRACT

A method for quantum computing includes providing an array of qubits having an internal transition frequency from a ground state to an excited state. A two-qubit gate, including two of the qubits in the array, is initialized to a first state. The two-qubit gate is switched by applying, for a time sufficient to drive the two-qubit gate to a second state, radiation including simultaneously first upper and lower spectral components (60, 62), having a first amplitude, in upper and lower displacement sidebands, respectively, of the internal transition frequency, and second upper and lower spectral components (64, 66), having a second amplitude with a magnitude that is at least 10% of the first amplitude, in upper and lower squeezing sidebands, respectively, of the internal transition frequency.

### CROSS-REFERENCE TO RELATED APPLICATION

This application claims the benefit of U.S. Provisional Patent Application 63/287,105, filed Dec. 8, 2021, which is incorporated herein by reference.

### FIELD

The present invention relates generally to quantum computing, and particularly to control of trapped-ion gates in a quantum computer.

### BACKGROUND

Quantum computers apply principles of quantum physics in solving computational problems and have the potential to perform certain computations far more efficiently than existing digital computers. The basic building block of a quantum computer is the qubit. Quantum computers comprise quantum gates built up from qubits, including single-qubit, two-qubit, and multi-qubit gates.

Trapped-ion systems, in which individual atomic ions serve as qubits, hold promise as a scalable, reliable platform for quantum computing. In a trapped-ion system, the individual atomic ions are trapped by electric fields in an ultra-high vacuum and are cooled to their motional ground states. The internal electronic levels of the ions, as well as the motion of the ions in the trap, are controlled with high precision using lasers, microwaves, or radio-frequency (RF) fields. To perform computations, gates are applied to the input states of the atomic ions by driving fields of the appropriate frequencies, amplitudes and duration.

The term “amplitude,” as used in the present description and the claims, refers to the complex amplitude, which includes both the magnitudes and the phases of the driving fields.

### SUMMARY

Embodiments of the present invention that are described hereinbelow provide improved trapped-ion gates and methods for driving such gates.

There is therefore provided, in accordance with an embodiment of the invention, a method for quantum computing, which includes providing an array of qubits having an internal transition frequency from a ground state to an excited state. A two-qubit gate, including two of the qubits in the array, is initialized to a first state. The two-qubit gate is switched by applying, for a time sufficient to drive the two-qubit gate to a second state, radiation including simultaneously first upper and lower spectral components, having a first amplitude, in upper and lower displacement sidebands, respectively, of the internal transition frequency, and second upper and lower spectral components, having a second amplitude with a magnitude that is at least 10% of the first amplitude, in upper and lower squeezing sidebands, respectively, of the internal transition frequency.

In a disclosed embodiment, the first state is an unentangled state, and the second state has a target entanglement phase φ≠0.

In some embodiments, the first upper and lower spectral components have first frequencies given by ƒ₁=ω±(v+nξ), and the second upper and lower spectral components have second frequencies given by ƒ₂=ω±(2v+mξ), wherein ω is the internal transition frequency, v is a phonon frequency of the array of qubits, ξ is a detuning frequency, and m and n are integers. In some of these embodiments, applying the radiation includes applying multiple first upper and lower spectral components having different, respective values of n and multiple second upper and lower spectral components having different, respective values of m. In a disclosed embodiment, the multiple first upper and lower spectral components and multiple second upper and lower spectral components have different respective amplitudes, including at least one positive amplitude and at least one negative amplitude.

In an alternative embodiment, the magnitude of the second amplitude is at least 50% of the first amplitude.

In some embodiments, applying the radiation includes choosing the first and second upper and lower spectral components and the first and second amplitudes so as to increase a fidelity of the two-qubit gate under deviations in a Rabi frequency of the radiation. Additionally or alternatively, applying the radiation includes choosing the first and second upper and lower spectral components and the first and second amplitudes so as to increase a fidelity of the two-qubit gate under deviations in a duration of application of the radiation relative to a switching time of the two-qubit gate.

In some embodiments, providing the array of qubits includes trapping an array of ions in an ion trap, wherein the two-qubit gate includes two of the ions in the array. In one embodiment, the internal transition frequency is an electronic transition frequency, and applying the radiation includes applying laser radiation.

In a disclosed embodiment, the first upper and lower spectral components and the second upper and lower spectral components are all phase-coherent.

Additionally or alternatively, applying the radiation includes choosing the first and second upper and lower spectral components and the first and second amplitudes so as to increase a fidelity of the two-qubit gate under deviations in a phonon frequency and temperature of the array of qubits.

In a disclosed embodiment, applying the radiation includes choosing the first upper and lower spectral components and the second upper and lower spectral components to satisfy constraints C1 through C6 as defined in the specification in Table I.

There is also provided, in accordance with an embodiment of the invention, a system for quantum computing, including an array of qubits having and internal transition frequency from a ground state to an excited state. A radiation source is configured to apply to the qubits in the array radiation including simultaneously first upper and lower spectral components, having a first amplitude, in upper and lower displacement sidebands, respectively, of the internal transition frequency, and second upper and lower spectral components, having a second amplitude with a magnitude that is at least 10% of the first amplitude, in upper and lower squeezing sidebands, respectively, of the internal transition frequency. A controller is configured to initialize a two-qubit gate, including two of the qubits in the array, to a first state and to switch the two-qubit gate by driving the radiation source to apply the radiation including the first upper and lower spectral components at the first amplitude and second upper and lower spectral components at the second amplitude for a time sufficient to drive the two-qubit gate to a second state.

There is additionally provided, in accordance with an embodiment of the invention, a method for quantum computing, which includes providing an array of qubits having an internal transition frequency from a ground state to an excited state. A two-qubit gate, including two of the qubits in the array, is initialized to a first state. The two-qubit gate is switched by applying, for a time sufficient to drive the two-qubit gate to a second state, radiation including simultaneously first spectral components w₁(t) in upper and lower displacement sidebands of the internal transition frequency and second spectral components w₂(t) in upper and lower squeezing sidebands, respectively, of the internal transition frequency. The first and second spectral components have respective frequencies and amplitudes satisfying constraints C1 through C6 as defined in the specification in Table I.

In a disclosed embodiment, the first state is an unentangled state, and the second state has a target entanglement phase φ≠0, and the target entanglement phase is φ=−π/2 for full entanglement.

There is further provided, in accordance with an embodiment of the invention, a method for quantum computing, which includes providing an array of qubits having an internal transition frequency from a ground state to an excited state. A multi-qubit gate, including three or more of the qubits in the array, is initialized to a first state. The multi-qubit gate is switched by applying, for a time sufficient to drive the multi-qubit gate to a second state, radiation including simultaneously first upper and lower spectral components, having a first amplitude, in upper and lower displacement sidebands, respectively, of the internal transition frequency, and second upper and lower spectral components, having a second amplitude with a magnitude that is at least 10% of the first amplitude, in upper and lower squeezing sidebands, respectively, of the internal transition frequency.

In some embodiments, applying the radiation includes choosing the first and second upper and lower spectral components and the first and second amplitudes so as to increase a fidelity of the multi-qubit gate under deviations in an operating parameter of the multi-qubit gate.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a quantum computing system, in accordance with an embodiment of the invention;

FIG. 2 is a block diagram that schematically illustrates an array of trapped ions configured as qubits in a quantum computer, in accordance with an embodiment of the invention;

FIG. 3 is an energy level diagram that schematically illustrates a two-qubit gate based on trapped ions, in accordance with an embodiment of the invention;

FIG. 4A is a plot that schematically shows a spectrum of laser frequencies applied to drive a two-qubit gate based on trapped ions, in accordance with an embodiment of the invention;

FIG. 4B is a plot that schematically shows a temporal modulation of a laser beam that is applied to drive a two-qubit gate based on trapped ions, in accordance with an embodiment of the invention;

FIG. 5A is a plot that schematically illustrates the fidelity of two-qubit gates, including a gate that is driven in accordance with an embodiment of the invention; and

FIG. 5B is a plot that schematically illustrates the infidelity of the two-qubit gates of FIG. 5A.

### DETAILED DESCRIPTION

### Overview

In quantum computing, fidelity (F) is a key indicator of the performance of a given quantum gate. The fidelity is a statistical measure of the difference between the states of a practical, physical gate and of an ideal gate following a state switching operation. For fault-tolerant quantum computing on a practical scale, the gate infidelity (1-F) should be very small, for example no greater than 10⁻⁴. Achieving this level of fidelity in two-qubit gates and multi-qubit systems generally remains a major challenge.

Multi-qubit entanglement gates are crucial to quantum computing, as they are an essential part of a universal gate set. In trapped-ion systems, entanglement gates are typically generated by driving the ions with electromagnetic fields that create phonon-mediated qubit-qubit interactions. One scheme that can be used for this purpose is the Mølmer-Sørensen (MS) gate, in which the two-qubit gate is switched by applying laser radiation simultaneously to the upper and lower displacement sidebands of an internal transition frequency of the ions. The “displacement sidebands” are defined as frequency bands detuned above and below the center frequency of the internal transition by a phonon frequency corresponding to the normal vibrational modes of the array of ions in the ion trap. The upper and lower sidebands are also referred to as the “blue” and “red” sidebands.

The MS gate is thus switched by applying laser radiation to the trapped ions at frequencies ƒ₁=ω±(v+ξ), wherein ω is the internal transition frequency, v is a phonon frequency of the array of ions in the ion trap, and ξ is a detuning frequency, which is much smaller than v. In the description below, for the sake of clarity and concreteness, the transition frequency ω is assumed to be the frequency of a suitable electronic transition in a trapped-ion system, which is excited using laser radiation. The principles of the present invention may alternatively be applied, mutatis mutandis, to quantum gates applied to other trapped-ion transitions, such as transitions between spin states of a Zeeman-split manifold, or between states in hyperfine-split manifolds, as well as to other types of quantum gates, in which case microwave or radiofrequency excitation may be used.

The MS gate, however, is sensitive to the amplitude of the laser field and exhibits a degradation of fidelity that is quadratic in field intensity noise (or, equivalently, in variations in the Rabi frequency Ω, which is proportional to the vector electric field amplitude of the laser radiation). Thus, even small deviations in the laser intensity or in the beam-pointing accuracy or polarization can cause the infidelity to rise to unacceptable levels. Other sources of infidelity can include deviations in the phonon frequency of the ion array, heating of the phonon mode, and inaccuracy in the duration over which the laser radiation is applied in switching the gate relative to the ideal switching time.

Embodiments of the present invention that are described herein address these problems by applying phase-coherent laser radiation to the two-qubit gate with substantial intensity at frequencies in upper and lower squeezing sidebands of the internal atomic transition frequency, in addition to the phase-coherent radiation at the displacement sidebands frequencies. The “squeezing sidebands” are defined as frequency bands displaced above and below the internal atomic transition frequency by twice the phonon frequency of the normal vibrational modes of the array of ions in the ion trap, i.e., at frequencies ƒ₂=ω±(2v+mξ), wherein m is an integer (which may be positive or negative). The amplitude of the phase-coherent laser radiation in the squeezing sidebands has a magnitude that is at least 10% of the amplitude of the laser radiation in the displacement sidebands, and may be 50% or more of the amplitude of the laser radiation in the displacement sidebands.

In some embodiments, the laser source may irradiate the ions in the two-qubit gate with phase-coherent multiple frequency components in the squeezing sidebands, having different values of the integer parameter m and different, respective amplitudes. The laser irradiation may have multiple phase-coherent frequency components in the displacement sidebands, as well. The frequencies and amplitudes of these phase-coherent frequency components, which may be positive or negative, are optimized using a protocol comprising constraints that maximize the fidelity of the gate in the face of variations in the amplitude of the laser radiation and other noise factors. By appropriate choice of frequencies, phases, and amplitudes, the fidelity of the gate can be made robust against variations in the laser amplitude. For example, infidelity can be made to scale as the inverse of the fourth power of deviations in the Rabi frequency (1−F˜Ω⁻⁴) or with other functional scaling depending on the frequencies, phases, and amplitudes of the frequency components. Additionally or alternatively, in similar fashion, the fidelity can be made robust against variations in the phonon frequency Av and in the switching time AT.

Although the embodiments described below relate specifically to two-qubit gates, the principles of the present invention may be extended to create robust multi-qubit gates with three or more qubits. Like the two-qubit gates described herein, these multi-qubit gates use spin-dependent forces for coupling internal qubit-spin states to motion, and they are susceptible to loss of fidelity due to deviations in the Rabi frequency and other parameters. In alternative embodiments of the present invention, the robustness of such multi-qubit gates is enhanced by application of phase-coherent electromagnetic fields with appropriate amplitudes and detuning in upper and lower displacement sidebands and upper and lower squeezing sidebands. As gates with three or more qubits have multiple vibrational modes that can be used to couple the internal states of the qubits, the displacement and squeezing sidebands may be chosen according to the phonon frequencies of any of the normal vibrational modes.

Furthermore, although the embodiments described herein relate specifically to trapped-ion quantum computing systems, the principles of the present invention may alternatively be applied, mutatis mutandis, to arrays of qubits of other sorts, such as superconducting (SC) qubits or an array of trapped neutral atoms inside an optical cavity. In trapped-ion systems, the qubits exploit the internal electronic degrees of freedom of the trapped ions (such as the electronic spins), while interactions between qubits are mediated by bosons based on the harmonic phonon modes. SC qubits exploit transmons, for example, and their interactions are mediated by bosons based on photonic excitation of a waveguide resonator to which all the SC qubits are coupled. Similar Gates built from these SC qubits are known as Resonator-Induced Phase (RIP) gates. In an alternative embodiment of the present invention, RIP qubits of this sort can similarly be switched by combined excitation of displacement and squeezing sidebands defined by the resonator modes, with excitation amplitudes chosen so that the gate fidelity is robust against variations in the Rabi frequency.

### System Description

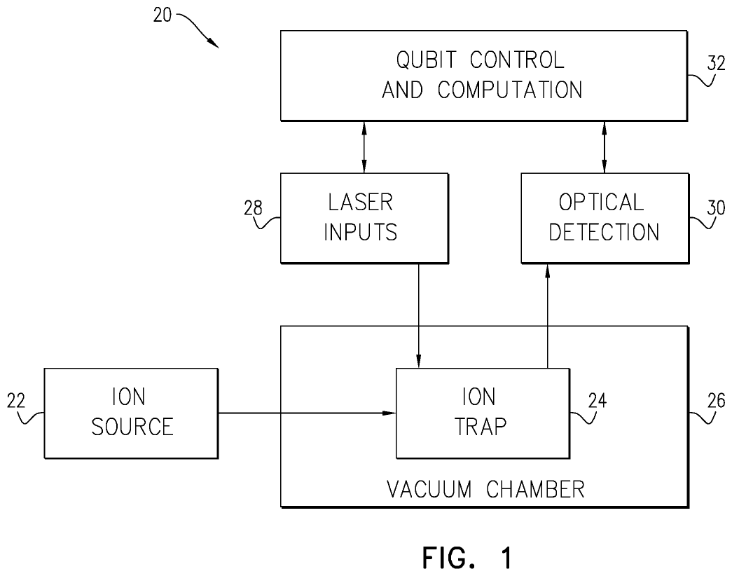

FIG. 1 is a block diagram that schematically illustrates a quantum computing system 20, in accordance with an embodiment of the invention. An atom source 22 injects a flow of neutral atoms, such as atoms of calcium, into a vacuum chamber 26 at ultra-high vacuum. A radiation source 28 directs several beams of radiation into vacuum chamber 26, including a beam that is tuned to ionize the atoms injected by source 22. (In the present example, as noted above, system 20 is assumed to be based on electronic transitions, and radiation source 28 is assumed to comprise lasers emitting beams of coherent radiation; but ionization, for example, may alternatively be carried out using an incoherent beam.) The resulting atomic ions are captured in an ion trap 24, such as a Paul trap, which uses RF fields to confine the ions along a specified line within the vacuum chamber 26. A magnetic field may also be applied to ion trap 24 to separate the different spin components of the electronic states of the ions into Zeeman levels.

An electronic qubit control and computation processor 32 drives radiation source 28 to direct additional beams toward the trapped ions in order to perform quantum computational operations and then read out the computational results. Typically, the results are read out by tuning a laser beam to an absorption line of one of the qubit states and then measuring the resulting fluorescent emission using an optical detector 30. Processor 32 receives the result of the computation and drives laser source 28 to perform additional computational steps in accordance with the algorithm being implemented.

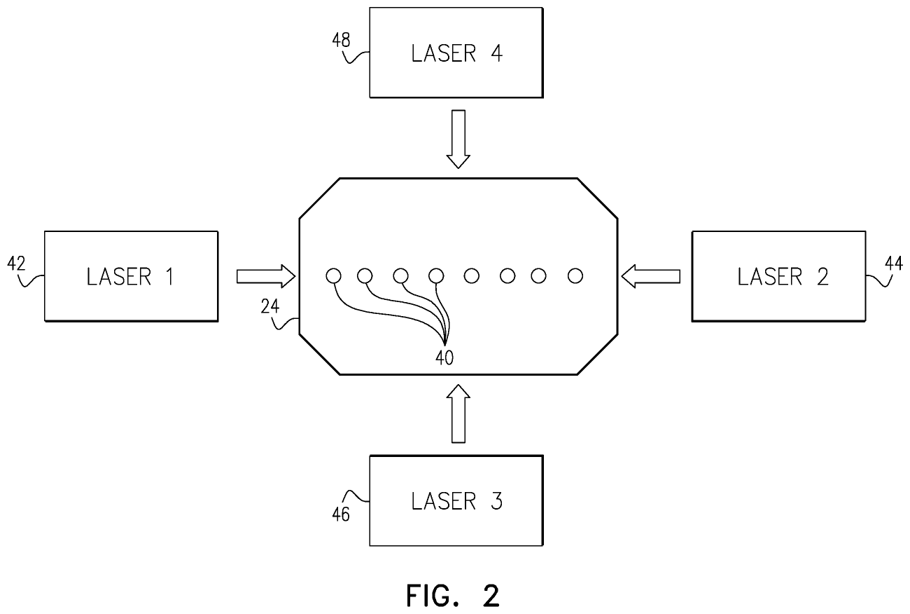

FIG. 2 is a block diagram that schematically illustrates an array of trapped ions 40 configured as qubits in a quantum computer, such as in system 20, in accordance with an embodiment of the invention. Laser source 28 (FIG. 1), provides several different laser beam inputs to ion trap 24 for different purposes. An ionization laser 42 ionizes the atoms output by atom source 22 to create ions 40, which are held in the trap. Additional cooling lasers 44 cool the ions to their electronic and motional grounds states, by pumping appropriate state transitions of the ions while detuning the laser frequencies to engender mechanisms of Doppler cooling, sideband cooling, polarization gradient cooling, cooling by electrically-induced transparency (EIT), and/or other methods of colling that are known in the art.

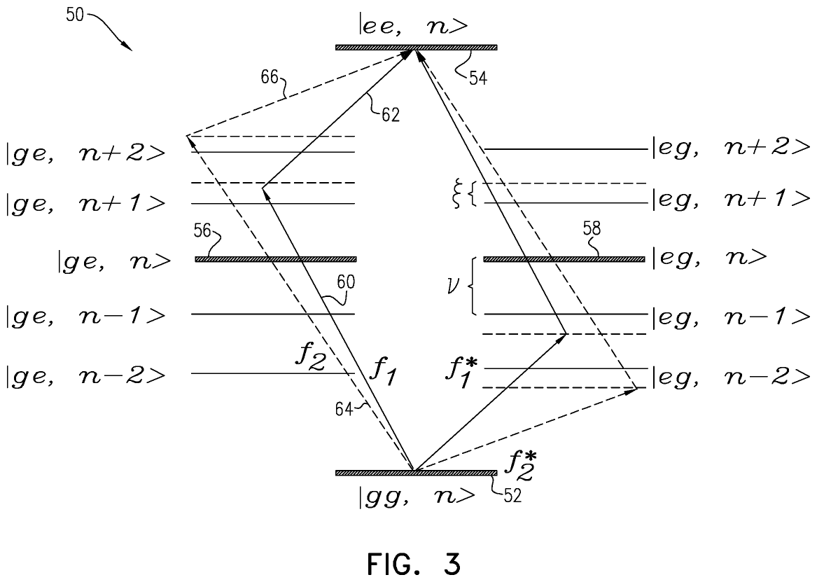

The cooled ions 40 are held in a linear array by the electromagnetic fields within trap 24. Coulomb repulsion between ions 40 and trapping fields determine the equilibrium distance between the ions and also determines the phonon frequency v of the vibrational modes of motion of ions 40 in the array. These vibrational modes give rise to vibrational sidebands of the optical transition frequencies between the states of ions 40. Absorption of a photon in one of these sideband frequencies causes the array of ions to vibrate while driving the internal transition of the absorbing ion, thus transferring energy to the normal modes of the ion array and entangling the internal and motional states of the ions by a spin-dependent force. This process is described below in greater detail with reference to FIG. 3. The mechanism of entanglement that it provides enables application of multi-qubit gates to these ions 40, such as a two-qubit gate of the type that is described herein.

To operate the two-qubit gate, an excitation laser 46 (or multiple lasers) coherently irradiates ions 40 on appropriate sidebands of a selected internal transition of the ions. The beam of laser 46 is modulated, for example by a suitable acousto-optic modulator, to coherently include frequency components in both the displacement sidebands (ƒ₁=ω±(v+ξ)) and the squeezing sidebands (ƒ₂=ω±(2v+mξ)), as defined above. The amplitudes of the frequency components are chosen, using a protocol that is described further hereinbelow, so as to optimize the robustness of the two-qubit gate against various sources of noise, including (but not limited to) variations in the Rabi frequency of laser 46. Laser 46 is operated in this manner for a gate time T that is suitable for driving the two-qubit gate from its initial state to an entangled target state.

After completion of the computational cycle, a readout laser 48 reads the state of the gate or gates among ions 40. Readout laser 48 is tuned to an absorption band of one of the states of the ions in the gate. Absorption of the laser radiation by the ions in the appropriate state gives rise to fluorescence, which is measured by optical detector 30 (FIG. 1). Processor 32 measures the intensity of the fluorescent emissions and thus detects the final state of the gate.

FIG. 3 is an energy level diagram that schematically illustrates a two-qubit gate 50 based on trapped ions, in accordance with an embodiment of the invention. The spacing v between the vibrational energy levels and the detuning ξ of the laser frequencies are exaggerated, relative to the electronic transition frequencies used in the embodiment, for clarity and in practice are much smaller than the spacings between the internal states of the ions.

Each of the ions in gate 50 has an electronic ground state |g> and an internal excited state |e>, for example corresponding respectively to selected Zeeman spin levels within the |4S_{1/2}> and |3D_{5/2}> manifolds of Ca⁺. Thus, two-qubit gate 50 has a ground state 52 |gg,n>, in which both ions are in the respective ground states, and an excited state 54 |ee,n>, in which both ions are in the respective excited states, wherein n is the phonon number. Transitions between ground state 52 and excited state 54 take place by two-photon interaction through intermediate states 56 and 58, identified as |ge> and |eg>. Each of the intermediate states is split into multiple motional states that are separated by the phonon frequency v, for example |ge,n+2>, |ge,n+1>, |ge,n>, |ge,n−1>, and |ge,n−2>.

In the pictured embodiment, laser 46 (FIG. 2) applies four spectral components in order to switch gate 50:
Components 60 and 62, at respective frequencies f₁ and f₁* in the displacement sidebands of the state transition, i.e., via intermediate motional states at n=±1.
Components 64 and 66, at respective frequencies f₂ and f₂* in the squeezing sidebands of the state transition, i.e., via intermediate motional states at n=±2.
   As noted earlier, the amplitudes of components 64 and 66 have a magnitude at least 10% of the amplitude of components 60 and 62, and possibly 50% or higher. The amplitudes of the spectral components are chosen to make the fidelity of gate 50 robust against various noise sources and may be positive or negative in sign, i.e., with the corresponding electric fields in phase or antiphase, as appropriate to satisfy the criteria for robustness.

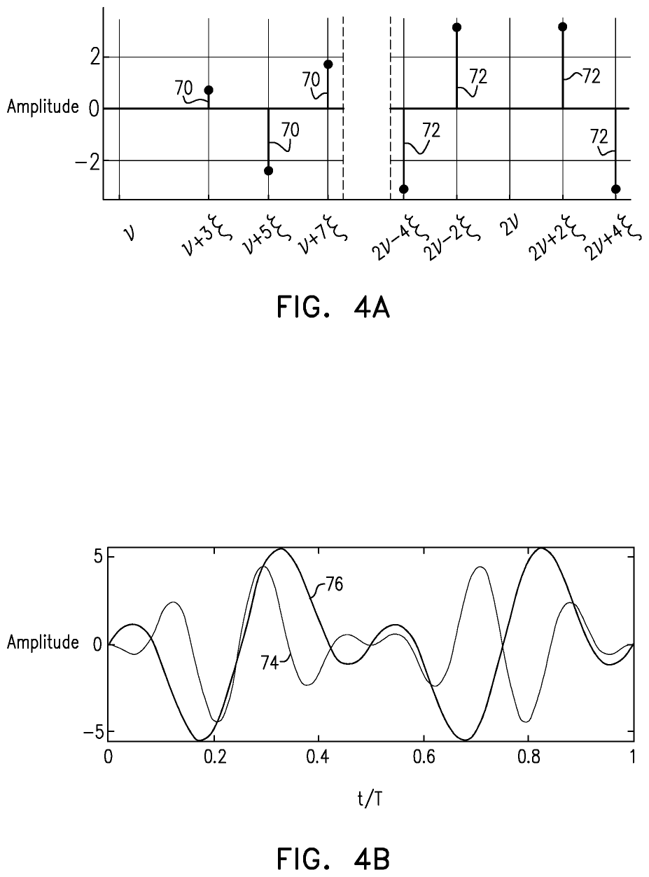

Although FIG. 3 shows only two spectral components in each of the displacement and squeezing bands, in practice laser 46 may apply a larger number of spectral components. Additionally or alternatively, although all the spectral components in FIG. 3 have the same detuning ξ relative to the respective motional states, other detuning factors, for example different multiples of ξ, may alternatively be used in generating the spectral components. A more complex multispectral scheme of this sort is shown in FIG. 4A, for example.

Furthermore, although the examples described herein use spectral components only in the displacement and squeezing sidebands, the principles of the present invention may be extended to create multi-qubit gates with coherent excitation in additional motional sidebands, for example third- and/or fourth-order sidebands f₃=ω±(3v+pξ) and f₄=ω±(4v+qξ), as well as sidebands in other motional modes. Such multi-band schemes are considered to be within the scope of the present invention.

The detuning ξ is a function of the Lamb-Dicke parameter n and the Rabi frequency Ω. In the Mølmer-Sørensen gate, in which only displacement sidebands are used, ξ=2\sqrt{n}ηΩ, wherein n is an integer. The Lamb-Dicke parameter is given by the ratio of the width of the wave function of the motional states of the ions to the laser wavelength:

$$η = k \sqrt{\frac{ℏ}{2 mv}}$$

Here k is the laser wave number, and m is the ion mass.

### Protocol for Selecting Sideband Amplitudes

In the example that is described hereinbelow, laser 46 drives a two-qubit trapped-ion gate with a beam having an amplitude W(t)=w₁(t)+w₂(t), wherein w₁(t) consists of frequency components f₁ in the displacement sidebands, while w₂(t) consists of frequency components f₂ in the squeezing sidebands. The laser beam, which may comprise a single beam that addresses the ions globally or multiple local beams addressing the ions individually, has a total Rabi frequency Ω and is applied to the gate for a time T. As explained above, the functional forms and parameters of w₁(t) and w₂(t) are chosen so that the final state of the two-qubit gate, at time T, varies slowly with deviations in the Rabi frequency ΔΩ, as well as with deviations in the phonon frequency Δv, in the temperature, and in the gate switching time ΔT. One protocol for this purpose is presented below. Various other mathematical methods may alternatively be applied in optimizing w₁(t) and w₂(t). All such methods are considered to be within the scope of the present invention. For convenience in defining the protocol, we define the parameter r(t):

$$r = - 2 {\int }_{0}^{t} d {t}^{′} {w}_{2} ( {t}^{′} )$$

We also use the following notational shorthand (for arbitrary functions f and g):

$$\{ f \} = {\int }_{0}^{t} d {t}_{1} f ( {t}_{1} )$$

$$\{ f \{ g \} \} = {\int }_{0}^{t} d {t}_{1} {\int }_{0}^{{t}_{1}} d {t}_{2} f ( {t}_{1} ) g ( {t}_{2} )$$

We define the following phase functions corresponding to the interaction between the ions in the two-qubit gate:

$${Φ}_{2} = Im [ \{ {w}_{1}^{*} cosh ( r ) \{ {w}_{1} cosh ( r ) \} \} ]$$

$${Φ}_{3} = Im [ \{ {w}_{1} cosh ( r ) \{ {w}_{1} sinh ( r ) \} \} ] + Im [ \{ {w}_{1}^{*} sinh ( r ) \{ {w}_{1}^{*} cosh ( r ) \} \} ]$$

$${Φ}_{4} = Im [ \{ {w}_{1} sinh ( r ) \{ {w}_{1}^{*} sinh ( r ) \} \} ]$$

At the gate time t=T, there should be no residual displacement or squeezing and no rotation of the spins of the ions. The entanglement at time T is expected to reach a target entanglement phase φ≠0, for example φ≠−π/2 for full entanglement, after starting from zero entanglement at t=0. The choice of frequency components should also be such that the entanglement phase is robust against variations in the Rabi frequency Ω. These requirements together impose the constraints listed below in Table I on w₁(t) and w₂(t):

TABLE I
CONSTRAINTS ON FREQUENCY COMPONENTS

C1: {w₁cosh (r)} = 0
C2: {w*₁sinh (r)} = 0
C3: r(t = T) = {w₂} = 0
C4: Φ₃(T) = 0
C5: Φ₂(T) + Φ₄(T) = φ
C6: ∂_{Ω}(Φ₂(T) + Φ₄(T)) = 0

The final constraint (C6) implies that the leading-order term in the variation of the entanglement phase with small changes in Ω is zero. C6 can alternatively be generalized to a series of constraints with increasing orders of differentiation, ∂_{Ω}ⁿ.

The constraints above do not uniquely define w₁(t) and w₂(t), and various solutions can be developed to provide robustness against different types of noise. All such solutions are considered to be within the scope of the present invention. In other words, after reading the present disclosure, the person of ordinary skill in the art will be able readily to verify whether or not a given choice of w₁(t) and w₂(t) satisfies the constraints in Table I, as well as to apply analytical and computational methods that are known in the art to find other solutions.

One particular family of solutions to the constraints in Table I is presented hereinbelow, assuming that φ=−π/2. To satisfy the integral constraints (C1, C2, and C3), the integrands are composed of non-zero multiples of the gate rate (detuning frequency) ξ=2π/T, giving a set of detuned frequencies in each motional sideband. The following waveforms will satisfy the first four constraints:

$${w}_{1} ( t ) = {\sum }_{n} {a}_{2 n + 1} {e}^{i ξ ( 2 n + 1 ) t}$$

$$r ( t ) = {\sum }_{n} {s}_{2 n} sin ( 2 ξ n t )$$

Here w₁(t) comprises odd harmonics with coefficients a₂ₙ₊₁, while r(t) comprises even harmonics with coefficients s₂ₙ.

Various choices of the coefficients a₂ₙ₊₁ and s₂ₙ can satisfy constraints C5 and C6. A simple solution, with relatively few harmonics, is the following:

$${w}_{1} ( t ) = \frac{a}{3} ( 3 {e}^{3 i ξ t} - 10 {e}^{5 i ξ t} + 7 {e}^{7 i ξ t} )$$

$$r ( t ) = s ( sin ( 2 ξ t ) - \frac{1}{2} sin ( 4 ξ t ) )$$

Numerical optimization gives the coefficient values a=0.3608·ξ and s=0.7820. In this example, the amplitudes of the spectral components of the laser field in the squeezing sidebands have magnitudes greater than those of the spectral components in the displacement sidebands.

The Rabi frequency that is required to drive the two-qubit gate in accordance with this spectral scheme is Ω_{robust}≈(3/η+6/η²)ξ. This frequency value is greater than the Rabi frequency of a conventional Mølmer-Sørensen gate, for example, meaning that laser 46 operates at higher intensity in the present scheme in order to drive the squeezing sidebands. In practical applications of quantum computing, however, the limit on computer performance is typically fidelity, rather than laser power.

Although the example presented above relates to transitions from an initial ground state with unentangled phase (φ=0) to a target excited state with entanglement phase φ≠0 (and specifically φ=−π/2), the techniques described herein are likewise applicable to substantially any state transition of the two-qubit gate, including transitions from entangled to unentangled states.

FIGS. 4A and 4B are plots that schematically illustrate the scheme derived above for driving a two-qubit gate based on trapped ions, in accordance with an embodiment of the invention. FIG. 4A is a spectral plot that shows frequency components 70 in the displacement sideband and frequency components 72 in the squeezing sideband. The amplitudes in both FIGS. 4A and 4B are normalized in units of ξ/ηⁿ, wherein n is the sideband order.

FIG. 4B is a temporal plot that schematically shows the modulation of the beam emitted by laser 46 over the gate period T, including a displacement component 74 and a squeezing component 76. Both components 74 and 76 vanish at the beginning and end of the gate period, thus reducing off-resonance coupling to unwanted transitions and reducing sensitivity to deviations in the Rabi frequency and gate time.

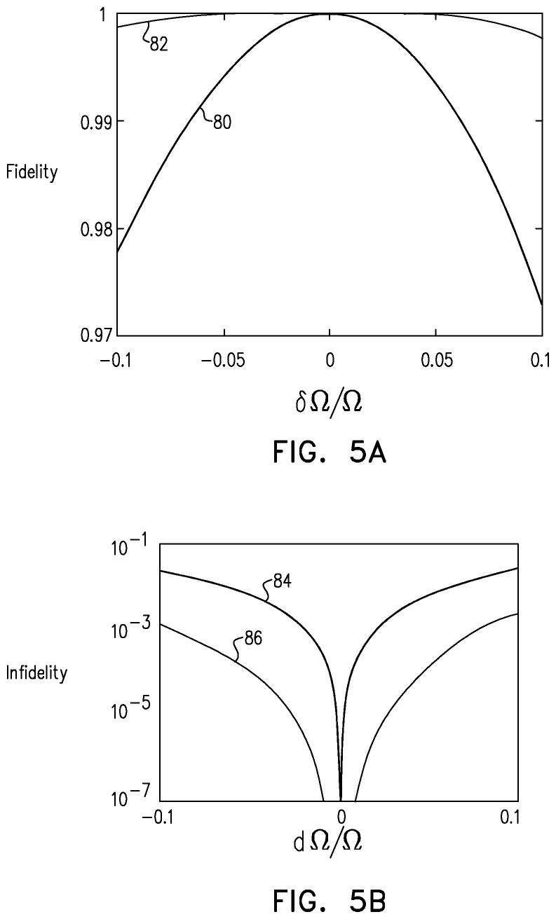

FIG. 5A is a plot that schematically illustrates the fidelity of two-qubit gates as a function of small deviations δΩ in the Rabi frequency, in accordance with an embodiment of the invention. A curve 80 shows the fidelity of a conventional Mølmer-Sørensen gate, which drops sharply with even small deviations. A curve 82 shows the fidelity of a gate that is driven in both the displacement and squeezing sidebands as described above. The fidelity in this case is nearly constant over small values of δΩ and drops with increasing deviation as δΩ⁴. Thus, fidelity remains close to 0.999 even for a 10% deviation in the Rabi frequency.

FIG. 5B is a plot that schematically illustrates the infidelity 1-F of the two-qubit gate of FIG. 5A on a logarithmic scale. A curve 84 represents the infidelity of the Mølmer-Sørensen gate. A curve 86 represents the far lower infidelity of gate that is driven in both the displacement and squeezing sidebands, giving an improvement of about two orders of magnitude over the conventional gate.

Similar improvements in fidelity can be demonstrated in the face of errors in gate timing δT, errors in phonon frequency δv, and motional mode heating, as well as susceptibility of the infidelity to finite ion temperature.

The embodiments described above are cited by way of example, and the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for quantum computing, comprising:
providing an array of qubits having an internal transition frequency from a ground state to an excited state;
initializing a two-qubit gate, comprising two of the qubits in the array, to a first state; and
switching the two-qubit gate by applying, for a time sufficient to drive the two-qubit gate to a second state, radiation comprising simultaneously:
first upper and lower spectral components, having a first amplitude, in upper and lower displacement sidebands, respectively, of the internal transition frequency; and
second upper and lower spectral components, having a second amplitude with a magnitude that is at least 10% of the first amplitude, in upper and lower squeezing sidebands, respectively, of the internal transition frequency.

2. The method according to claim 1, wherein the first state is an unentangled state, and the second state has a target entanglement phase φ≠0.

3. The method according to claim 1, wherein the first upper and lower spectral components have first frequencies given by ƒ₁=ω±(v+nξ), and the second upper and lower spectral components have second frequencies given by ƒ₂=ω±(2v+mξ), wherein ω is the internal transition frequency, v is a phonon frequency of the array of qubits, ξ is a detuning frequency, and m and n are integers.

4. The method according to claim 3, wherein applying the radiation comprises applying multiple first upper and lower spectral components having different, respective values of n and multiple second upper and lower spectral components having different, respective values of m.

5. The method according to claim 4, wherein the multiple first upper and lower spectral components and multiple second upper and lower spectral components have different respective amplitudes, including at least one positive amplitude and at least one negative amplitude.

6. The method according to claim 1, wherein the magnitude of the second amplitude is at least 50% of the first amplitude.

7. The method according to claim 1, wherein applying the radiation comprises choosing the first and second upper and lower spectral components and the first and second amplitudes so as to increase a fidelity of the two-qubit gate under deviations in a Rabi frequency of the radiation.

8. The method according to claim 1, wherein applying the radiation comprises choosing the first and second upper and lower spectral components and the first and second amplitudes so as to increase a fidelity of the two-qubit gate under deviations in a duration of application of the radiation relative to a switching time of the two-qubit gate.

9. The method according claim 1, wherein providing the array of qubits comprises trapping an array of ions in an ion trap, wherein the two-qubit gate comprises two of the ions in the array.

10. The method according to claim 9, wherein the internal transition frequency is an electronic transition frequency, and wherein applying the radiation comprises applying laser radiation.

11. The method according to claim 1, wherein the first upper and lower spectral components and the second upper and lower spectral components are all phase-coherent.

12. The method according to claim 1, wherein applying the radiation comprises choosing the first and second upper and lower spectral components and the first and second amplitudes so as to increase a fidelity of the two-qubit gate under deviations in a phonon frequency and temperature of the array of qubits.

13. The method according to claim 1, wherein applying the radiation comprises choosing the first upper and lower spectral components and the second upper and lower spectral components to satisfy constraints C1 through C6 as defined in the specification in Table I.

14. A system for quantum computing, comprising:
an array of qubits having and internal transition frequency from a ground state to an excited state;
a radiation source, configured to apply to the qubits in the array radiation comprising simultaneously:
first upper and lower spectral components, having a first amplitude, in upper and lower displacement sidebands, respectively, of the internal transition frequency; and
second upper and lower spectral components, having a second amplitude with a magnitude that is at least 10% of the first amplitude, in upper and lower squeezing sidebands, respectively, of the internal transition frequency; and
a controller configured to initialize a two-qubit gate, comprising two of the qubits in the array, to a first state and to switch the two-qubit gate by driving the radiation source to apply the radiation comprising the first upper and lower spectral components at the first amplitude and second upper and lower spectral components at the second amplitude for a time sufficient to drive the two-qubit gate to a second state.

15. The system according to claim 14, wherein the first state is an unentangled state, and the second state has a target entanglement phase φ≠0.

16. The system according to claim 14, wherein the first upper and lower spectral components have first frequencies given by ƒ₁=ω±(v+nξ), and the second upper and lower spectral components have second frequencies given by ƒ₂=ω±(2v+mξ), wherein ω is the internal transition frequency, v is a phonon frequency of the array of qubits, ξ is a detuning frequency, and m and n are integers.

17. The system according to claim 16, wherein the controller is configured to drive the radiation source to switch the two-qubit gate by applying multiple first upper and lower spectral components having different, respective values of n and multiple second upper and lower spectral components having different, respective values of m.

18. The system according to claim 17, wherein the multiple first upper and lower spectral components and multiple second upper and lower spectral components have different respective amplitudes, including at least one positive amplitude and at least one negative amplitude.

19. The system according to claim 14, wherein the magnitude of the second amplitude is at least 50% of the first amplitude.

20. The system according to claim 14, wherein the first and second upper and lower spectral components and the first and second amplitudes are chosen so as to increase a fidelity of the two-qubit gate under deviations in a Rabi frequency of the radiation.

21. The system according to claim 14, wherein the first and second upper and lower spectral components and the first and second amplitudes are chosen so as to increase a fidelity of the two-qubit gate under deviations in a duration of application of the radiation relative to a switching time of the two-qubit gate.

22. The system according to claim 14, and comprising an ion trap, wherein the array of qubits comprises an array of ions held in the trap, and wherein the two-qubit gate comprises two of the ions in the array.

23. The system according to claim 22, wherein the internal transition frequency is an electronic transition frequency, and wherein applying the radiation comprises applying laser radiation.

24. The system according to claim 14, wherein the first upper and lower spectral components and the second upper and lower spectral components are all phase-coherent.

25. The system according to claim 14, wherein the first and second upper and lower spectral components and the first and second amplitudes are chosen so as to increase a fidelity of the two-qubit gate under deviations in a phonon frequency and temperature of the array of qubits.

26. The system according to claim 14, wherein the first upper and lower spectral components and the second upper and lower spectral components are chosen to satisfy constraints C1 through C6 as defined in the specification in Table I.

27. A method for quantum computing, comprising:
providing an array of qubits having an internal transition frequency from a ground state to an excited state;
initializing a two-qubit gate, comprising two of the qubits in the array, to a first state; and
switching the two-qubit gate by applying, for a time sufficient to drive the two-qubit gate to a second state, radiation comprising simultaneously:
first spectral components w₁(t) in upper and lower displacement sidebands of the internal transition frequency; and
second spectral components w₂(t) in upper and lower squeezing sidebands, respectively, of the internal transition frequency,
wherein the first and second spectral components have respective frequencies and amplitudes satisfying constraints C1 through C6 as defined in the specification in Table I.

28. The method according to claim 27, wherein the first state is an unentangled state, and the second state has a target entanglement phase φ≠0.

29. The method according to claim 28, wherein the target entanglement phase is φ=−π/2 for full entanglement.

30. The method according to claim 27, wherein the first spectral components have first frequencies given by ƒ₁=ω±(v+nξ), and the second spectral components have second frequencies given by ƒ₂=ω±(2v+mξ), wherein ω is the transition frequency, v is a phonon frequency of the array of qubits, ξ is a detuning frequency, and m and n are integers.

31. The method according to claim 30, wherein applying the radiation comprises applying multiple first spectral components having different, respective values of n and multiple second spectral components having different, respective values of m.

32. The method according to claim 31, wherein the multiple first spectral components and multiple second spectral components have different respective amplitudes, including at least one positive amplitude and at least one negative amplitude.

33. The method according to claim 27, wherein applying the radiation comprises choosing the respective frequencies and amplitudes of the first and second spectral components so as to increase a fidelity of the two-qubit gate under deviations in a duration of application of the radiation relative to a switching time of the two-qubit gate.

34. The method according to claim 27, wherein providing the array of qubits comprises trapping an array of ions in an ion trap, wherein the two-qubit gate comprises two of the ions in the array.

35. The method according to claim 34, wherein the given transition frequency is an electronic transition frequency, and wherein applying the radiation comprises applying laser radiation.

36. The method according to claim 27, wherein the first and second spectral components are all phase-coherent.

37. The method according to claim 27, wherein applying the radiation comprises choosing the respective frequencies and amplitudes of the first and second spectral components so as to increase a fidelity of the two-qubit gate under deviations in a phonon frequency and temperature of the array of qubits.

38. A method for quantum computing, comprising:
providing an array of qubits having an internal transition frequency from a ground state to an excited state;
initializing a multi-qubit gate, comprising three or more of the qubits in the array, to a first state; and
switching the multi-qubit gate by applying, for a time sufficient to drive the multi-qubit gate to a second state, radiation comprising simultaneously:
first upper and lower spectral components, having a first amplitude, in upper and lower displacement sidebands, respectively, of the internal transition frequency; and
second upper and lower spectral components, having a second amplitude with a magnitude that is at least 10% of the first amplitude, in upper and lower squeezing sidebands, respectively, of the internal transition frequency.

39. The method according to claim 38, wherein applying the radiation comprises choosing the first and second upper and lower spectral components and the first and second amplitudes so as to increase a fidelity of the multi-qubit gate under deviations in an operating parameter of the multi-qubit gate.
